(19) United States
(12) Patent Application Publication
(10) Pub. No.: US 2016/0035484 A1
(43) Pub. Date: Feb. 4, 2016

(54) CHIP ELECTRONIC COMPONENT AND METHOD OF MANUFACTURING THE SAME

(71) Applicant: SAMSUNG ELECTRO-MECHANICS CO., LTD., Suwon-Si (KR)

(72) Inventors: Ki Hyun PARK, Suwon-Si (KR); Il Ho AN, Suwon-Si (KR); Tae Do KWAK, Suwon-Si (KR)

(21) Appl. No.: 14/807,517

(22) Filed: Jul. 23, 2015

(30) Foreign Application Priority Data
Jul. 29, 2014 (KR) 10-2014-0096821

(51) Int. Cl. H01F 27/30; C08K 5/00; C08J 5/00; C08K 3/00; H01F 27/245; H01F 41/02

(52) U.S. Cl. CPC H01F 27/306; H01F 27/245; H01F 41/0233; C08J 5/00; C08K 3/0008; C08K 5/0008; C08J 2337/00; C08J 2333/00; C08J 2437/00; C08J 2433/00

(57) ABSTRACT

A chip electronic component includes a magnetic body in which internal coil part is embedded, and the magnetic body contains magnetic metal particles, a thermosetting resin, and a dispersing agent containing one or more selected from the group consisting of an acryl-based resin and a polyvinyl butyral (PVB)-based resin.

### CROSS-REFERENCE TO RELATED APPLICATION

This application claims the priority and benefit of Korean Patent Application No. 10-2014-0096821 filed on Jul. 29, 2014, with the Korean Intellectual Property Office, the disclosure of which is incorporated herein by reference.

### BACKGROUND

The present disclosure relates to a chip electronic component and a method of manufacturing the same.

An inductor, a type of chip electronic component, is a typical passive element for removing noise by configuring an electronic circuit, together with a resistor and a capacitor.

A thin film type inductor may be manufactured by forming an internal coil part and then stacking, compressing, and hardening sheets of a magnetic material formed of a mixture of magnetic particles and resin.

### SUMMARY

An aspect of the present disclosure may provide a chip electronic component capable of implementing a high degree of inductance by improving dispersibility and sedimentation stability as well as a packing factor of magnetic particles, and a method of manufacturing the same.

According to an aspect of the present disclosure, a chip electronic component may include: a magnetic body in which an internal coil part is embedded, wherein the magnetic body contains: magnetic metal particles; a thermosetting resin; and a dispersing agent containing one or more selected from the group consisting of an acryl-based resin and a polyvinyl butyral (PVB)-based resin.

According to another aspect of the present disclosure, a method of manufacturing a chip electronic component, may include forming an internal coil part on at least one surface of an insulating substrate; and forming a magnetic body in which the internal coil part is embedded by stacking magnetic sheets on upper and lower portions of the insulating substrate which the internal coil part is formed. The magnetic sheet may contain magnetic metal particles, a thermosetting resin, and a dispersing agent containing one or more selected from the group consisting of an acryl-based resin and a polyvinyl butyral (PVB)-based resin.

### BRIEF DESCRIPTION OF DRAWINGS

FIG. 1 is a schematic perspective view illustrating an example of a chip electronic component.

FIG. 2 is a cross-sectional view taken along line I-I′ of FIG. 1.

FIG. 3 is a flowchart illustrating an example of a method of manufacturing a chip electronic component.

FIGS. 4A and 4B are graphs comparing degrees of sedimentation stability of a slurry depending on a content of an acryl-based resin and degrees of sedimentation stability of a slurry depending on a content of a polyvinyl butyral (PVB)-based resin, respectively.

FIGS. 5A and 5B are graphs comparing degrees of film density of a magnetic sheet depending on a content of an acryl-based resin and degrees of film density of a magnetic sheet depending on a content of a polyvinyl butyral (PVB)-based resin, respectively.

FIGS. 6A and 6B are graphs comparing degrees of surface roughness of a magnetic sheet depending on a content of an acryl-based resin and degrees of surface roughness of a magnetic sheet depending on a content of a polyvinyl butyral (PVB)-based resin, respectively.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements. As used herein, the singular forms “a,” “an” and “the” include plural referents unless the context clearly dictates otherwise.

### Chip Electronic Component

Hereinafter, a chip electronic component according to an exemplary embodiment in the present disclosure, in detail, a thin film type inductor, will be described. However, the present disclosure is not limited thereto.

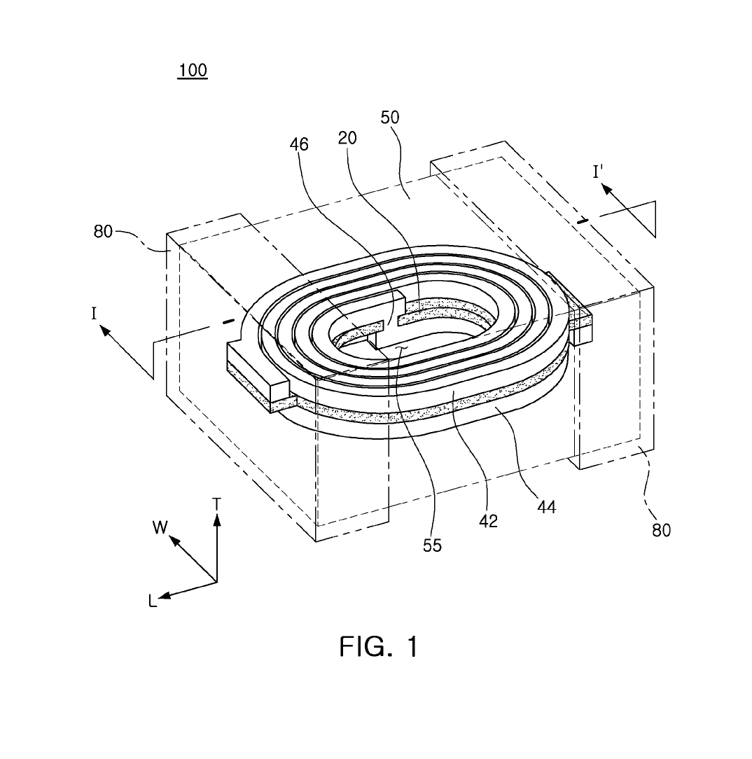

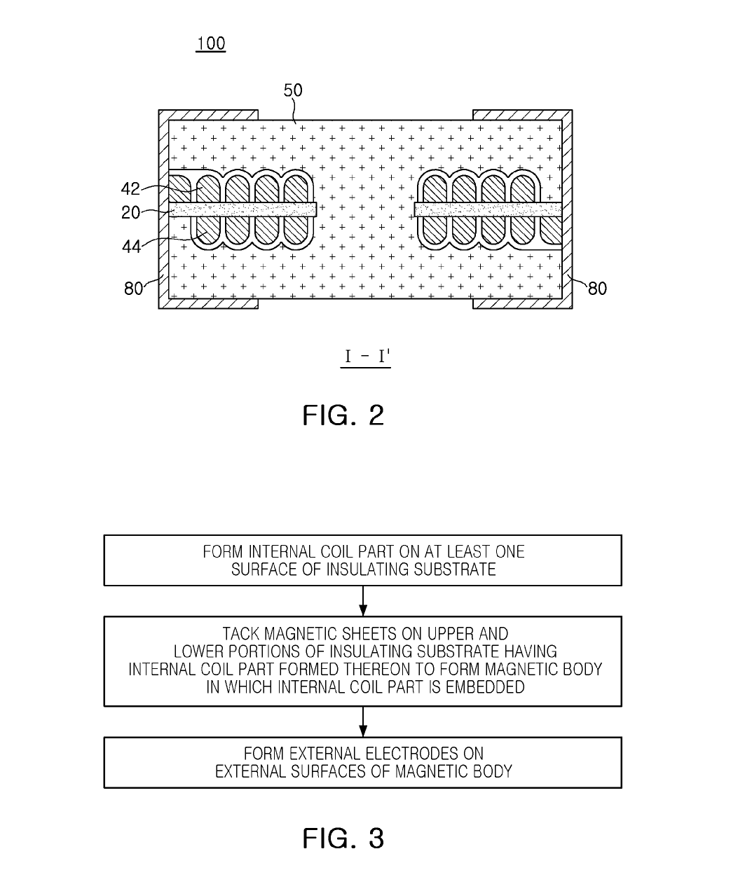

FIG. 1 is a schematic perspective view illustrating an example of a chip electronic component; and FIG. 2 is a cross-sectional view taken along line I-I′ of FIG. 1.

Referring to FIGS. 1 and 2, as an example of a chip electronic component, a thin film type inductor 100 provided on a power line of a power supply circuit is provided.

The chip electronic component 100 according to the exemplary embodiment in the present disclosure may include a magnetic body 50, internal coil parts 42 and 44 embedded in the magnetic body 50, and external electrodes 80 disposed on external surfaces of the magnetic body 50 and electrically connected to the internal coil parts 42 and 44.

In the chip electronic component 100 according to the exemplary embodiment in the present disclosure, a ‘length’ direction is an ‘L’ direction of FIG. 1, a ‘width’ direction is a ‘W’ direction of FIG. 1, and a ‘thickness’ direction is a ‘T’ direction of FIG. 1.

The magnetic body 50 may form an outer casing of the thin film type inductor 100, and may be formed by stacking, compressing, and hardening magnetic sheets formed as sheets containing magnetic particles.

As the magnetic particles configuring the magnetic body 50, magnetic metal particles, a metal-based soft magnetic material, may be used.

The magnetic metal particles may be formed of an alloy containing one or more selected from the group consisting of iron (Fe), silicon (Si), chromium (Cr), aluminum (Al), and nickel (Ni). For example, the magnetic metal particles may be Fe—Si—B—Cr-based amorphous metal particles, but are not limited thereto.

The particle diameter of the magnetic metal particles may be 0.1 to 30 μm.

The magnetic metal particles may be contained in a state of being dispersed in a thermosetting resin.

The thermosetting resin may be one or more selected from the group consisting of an epoxy resin and a polyimide resin, but is not limited thereto.

The magnetic metal particles have been grain-refined due to a gradual decrease in a size thereof in order to implement higher functions, and a mixture of two or more kinds of magnetic metal powders having different particle sizes has been used. Therefore, dispersing of the magnetic metal particles have become increasingly difficult. Accordingly, more effective methods that may allow for dispersibility have been demanded.

Therefore, an example may contain one or more selected from the group consisting of an acryl-based resin and a polyvinyl butyral (PVB)-based resin as a dispersing agent for improving dispersibility of the magnetic metal particles.

The dispersing agent may be adsorbed to the magnetic metal particles to generate steric hindrance between the magnetic metal particles, thereby preventing aggregation between the magnetic metal particles and improving a packing factor of the magnetic metal particles through particle rearrangement.

The acryl-based resin or the polyvinyl butyral (PVB)-based resin may improve sedimentation stability of the magnetic metal particles since, for example, an absorber such as a hydroxyl group (—OH) may be adsorbed more effectively to the magnetic metal particles.

The acryl-based resin or the polyvinyl butyral (PVB)-based resin may be used with other dispersing agents to significantly increase a dispersibility improvement effect.

An average molecular weight of the acryl-based resin may be 500,000 to 1,000,000.

An average molecular weight of the polyvinyl butyral (PVB)-based resin may be 50,000 to 100,000.

In a case in which the average molecular weight of the acryl-based resin is less than 500,000, or the average molecular weight of the polyvinyl butyral (PVB)-based resin is less than 50,000, polymer chains of the acryl-based resin or the polyvinyl butyral (PVB)-based resin may be relatively short, such that aggregation of the acryl-based resin or the polyvinyl butyral (PVB)-based resin may be generated, whereby film density of the magnetic sheet may be decreased and inductance may be decreased.

Meanwhile, in a case in which the average molecular weight of the acryl-based resin exceeds 1,000,000 or the average molecular weight of the polyvinyl butyral (PVB)-based resin exceeds 100,000, polymer chains of the acryl-based resin or the polyvinyl butyral (PVB)-based resin may be excessively long, such that the polymer chains may not be properly spread out. Therefore, a steric hindrance effect and a cross-linking effect between the acryl-based resin or the polyvinyl butyral (PVB)-based resin and the thermosetting resin may be relatively low, such that a sedimentation stability improvement effect may be low.

A content of one or more dispersing agent selected from the group consisting of the acryl-based resin and the polyvinyl butyral (PVB)-based resin may be 1 wt % to 5 wt %, based on the thermosetting resin.

In a case in which a content of the dispersing agent is less than 1 wt %, dispersibility and sedimentation stability may be decreased, and the magnetic metal particles may be aggregated, such that a packing factor may be decreased and inductance may be decreased.

Meanwhile, in a case in which a content of the dispersing agent exceeds 5 wt %, chains of the acryl-based resin or the polyvinyl butyral (PVB)-based resin may be entangled with each other, such that a re-aggregation phenomenon in which the dispersing agent and the magnetic metal particles are re-aggregated may occur. Therefore, sedimentation stability may again be decreased, film density of the magnetic sheet may be decreased, such that inductance may be decreased, and a surface roughness of the magnetic sheet may be increased. In addition, in the case in which the content of the dispersing agent exceeds 5 wt %, the dispersing agent may be plasticized in a hardening process, such that a chip may be broken.

An insulating substrate 20 disposed in the magnetic body 50 may be provided as, for example, a polypropylene glycol (PPG) substrate, a ferritic substrate, a metal-based soft magnetic substrate, or the like.

The insulating substrate 20 may have a hole penetrating through a central portion thereof, and the hole may be filled with a magnetic material such as a metal-based soft magnetic material, or the like, to form a core part 55. The core part 55 filled with the magnetic material may be formed, thereby increasing inductance L.

The insulating substrate 20 may have the internal coil parts 42 and 44 formed on one surface and the other surface thereof, respectively, and the internal coil parts 42 and 44 may have coil shaped patterns.

The internal coil parts 42 and 44 may include coil patterns formed in a spiral manner, and the internal coil parts 42 and 44 respectively formed on one surface and the other surface of the insulating substrate 20, may be electrically connected to each other by a via electrode 46 formed in the insulating substrate 20.

The internal coil parts 42 and 44 and the via electrode 46 may be formed including a metal having excellent electrical conductivity, for example, silver (Ag), palladium (Pd), aluminum (Al), nickel (Ni), titanium (Ti), gold (Au), copper (Cu), platinum (Pt), alloys thereof, or the like.

One end portion of the internal coil part 42 formed on one surface of the insulating substrate 20 may be exposed to one end surface of the magnetic body 50 in a length direction thereof, and the other end portion of the internal coil part 44 formed on the other surface of the insulating substrate 20 may be exposed to the other end surface of the magnetic body 50 in the length direction thereof.

The external electrodes 80 may be formed on both end surfaces of the magnetic body 50 to be connected to lead portions of the internal coil parts 42 and 44 respectively exposed to both end surfaces of the magnetic body 50.

The external electrodes 80 may be formed including a metal having excellent electrical conductivity, for example, nickel (Ni), copper (Cu), tin (Sn), silver (Ag), alloys thereof, or the like.

Method of Manufacturing Chip Electronic Component

FIG. 3 is a flowchart illustrating an example of a method of manufacturing a chip electronic component.

Referring to FIG. 3, the internal coil parts 42 and 44 may be first formed on the insulating substrate 20.

The insulating substrate 20 may be, for example, a polypropylene glycol (PPG) substrate, a ferritic substrate, a metal-based soft magnetic substrate, or the like, but is not limited thereto. The insulating substrate 20 may have a thickness of 40 to 100 μm.

A method of forming the internal coil parts 42 and 44 may be, for example, an electroplating method, but is not limited thereto.

The internal coil parts 42 and 44 may be formed including a metal having excellent electrical conductivity, for example, silver (Ag), palladium (Pd), aluminum (Al), nickel (Ni), titanium (Ti), gold (Au), copper (Cu), platinum (Pt), or alloys thereof

A hole may be formed in a portion of the insulating substrate 20 and may be filled with a conductive material to form the via electrode 46, and the internal coil parts 42 and 44 respectively formed on one surface and the other surface of the insulating substrate 20 may be electrically connected to each other by the via electrode 46.

Processes such as drilling, laser processing, sand blasting, punching, or the like, may be performed on a central portion of the insulating substrate 20 to form a through-hole penetrating through the insulating substrate 20.

Next, an insulating film coating the internal coil parts 42 and 44 may be formed.

The insulating film may be formed by a method well-known in the art such as a screen printing method, an exposure and development method using photoresist (PR), a spray application method, or the like, but is not limited thereto.

Next, magnetic sheets may be stacked on upper and lower portions of the insulating substrate 20 having the internal coil parts 42 and 44 respectively formed thereon, to form the magnetic body 50 in which the internal coil parts 42 and 44 are embedded.

A slurry used for the manufacturing of the magnetic sheet may contain magnetic particles, a thermosetting resin, a hardener, a thickener, an organic solvent, a dispersing agent that may improve dispersibility of magnetic metal particles, and the like.

As the magnetic particles used for the manufacturing of the magnetic sheet, magnetic metal particles, which are formed of a metal-based soft magnetic material, may be used.

As the magnetic metal particles, an alloy containing one or more selected from the group consisting of Fe, Si, Cr, Al, and Ni may be used. For example, the magnetic metal particles may be Fe—Si—B—Cr-based amorphous metal particles, but are not limited thereto.

The magnetic metal particles may have a particle diameter of 0.1 to 30 μm.

The magnetic metal particles may be mixed with the thermosetting resin to form the slurry, and the formed slurry may be applied to a carrier film and subsequently dried to manufacture the magnetic sheet.

The thermosetting resin may be one or more selected from the group consisting of the epoxy resin and the polyimide resin, but is not limited thereto.

Here, the slurry used for the manufacturing of the magnetic sheet may contain one or more selected from the group consisting of the acryl-based resin and the polyvinyl butyral (PVB)-based resin as the dispersing agent for effectively dispersing the magnetic metal particles in the thermosetting resin.

The acryl-based resin or the polyvinyl butyral (PVB)-based resin may improve sedimentation stability of the magnetic metal particles since, for example, an absorber such as a hydroxyl group (—OH) may be more effectively adsorbed to the magnetic metal particles.

The acryl-based resin or the polyvinyl butyral (PVB)-based resin may be used together with other dispersing agents to significantly increase a dispersibility improvement effect.

An average molecular weight of the acryl-based resin may be 500,000 to 1,000,000.

An average molecular weight of the polyvinyl butyral (PVB)-based resin may be 50,000 to 100,000.

In a case in which the average molecular weight of the acryl-based resin is less than 500,000 or the average molecular weight of the polyvinyl butyral (PVB)-based resin is less than 50,000, polymer chains of the acryl-based resin or the polyvinyl butyral (PVB)-based resin may be relatively short, such that aggregation of the acryl-based resin or the polyvinyl butyral (PVB)-based resin may occur, whereby a specific gravity of the slurry may be decreased, film density of the magnetic sheet may be decreased, and inductance may be decreased.

Meanwhile, in a case in which the average molecular weight of the acryl-based resin exceeds 1,000,000 or the average molecular weight of the polyvinyl butyral (PVB)-based resin exceeds 100,000, polymer chains of the acryl-based resin or the polyvinyl butyral (PVB) based resin may be excessively long, such that the polymer chains may not be properly spread out. Therefore, a steric hindrance effect and a cross-linking effect between the acryl-based resin or the polyvinyl butyral (PVB)-based resin and the thermosetting resin may be relatively low, such that a sedimentation stability improvement effect may be low.

A content of one or more dispersing agent selected from the group consisting of the acryl-based resin and the polyvinyl butyral (PVB)-based resin may be 1 wt % to 5 wt %, based on the thermosetting resin.

In a case in which a content of the dispersing agent is less than 1 wt %, dispersibility and sedimentation stability may be decreased, and the magnetic metal particles may be aggregated, such that a packing factor may be decreased and inductance may be decreased.

Meanwhile, in a case in which a content of the dispersing agent exceeds 5 wt %, chains of the acryl-based resin or the polyvinyl butyral (PVB)-based resin may be entangled with each other, such that a re-aggregation phenomenon in which the dispersing agent and the magnetic metal particles are re-aggregated may occur. Therefore, sedimentation stability may again be decreased, film density of the magnetic sheet may be decreased, such that inductance may be decreased, and a surface roughness of the magnetic sheet may be increased.

The magnetic sheet manufactured according to the exemplary embodiment in the present disclosure may have a film density of 5.4 g/cm³ or more and a surface roughness of 0.9 μm or less.

The following Tables 1 and 2 show sedimentation stability of the slurry and physical properties of the magnetic sheet depending on contents of the acryl-based resin and the polyvinyl butyral (PVB)-based resin.

TABLE 1

| | Content (wt %) | | Sedi- | | | |
|---|---|---|---|---|---|---|
| | Acryl- | Thermo- | mentation | Film | Surface | Adhesive |
| | based | setting | Height | Density | Roughness | Property |
| | Resin | Resin | (mm) | (g/cm³) | (μm) | (gf) |
| 1 | 0 | 100 | 4.0 | 5.510 | 0.560 | 1.5 |
| 2 | 1 | 99 | 3.8 | 5.522 | 0.653 | 1.6 |
| 3 | 3 | 97 | 3.0 | 5.545 | 0.729 | 1.8 |
| 4 | 5 | 95 | 2.8 | 5.614 | 0.827 | 2.0 |
| 5 | 10 | 90 | 3.1 | 5.387 | 0.931 | 2.5 |
| 6 | 20 | 80 | 3.6 | 5.241 | 1.159 | 4.5 |
| 7 | 50 | 50 | 4.0 | 5.115 | 1.533 | 5.1 |
| 8 | 100 | 0 | 4.2 | 4.887 | 1.821 | 6.3 |

TABLE 2

| | Content (wt %) | | | | | |
|---|---|---|---|---|---|---|
| | PVB- | Thermo- | Sedimentation | Film | Surface | Adhesive |
| | based | setting | Height | Density | Roughness | Property |
| | Resin | Resin | (mm) | (g/cm³) | (μm) | (gf) |
| 1 | 0 | 100 | 4.0 | 5.510 | 0.560 | 1.5 |
| 2 | 1 | 99 | 3.7 | 5.527 | 0.641 | 1.6 |
| 3 | 3 | 97 | 3.1 | 5.532 | 0.699 | 1.7 |
| 4 | 5 | 95 | 2.9 | 5.603 | 0.857 | 1.9 |
| 5 | 10 | 90 | 3.2 | 5.377 | 0.943 | 2.4 |
| 6 | 20 | 80 | 3.5 | 5.231 | 1.147 | 4.4 |
| 7 | 50 | 50 | 4.1 | 5.011 | 1.521 | 5.1 |
| 8 | 100 | 0 | 4.3 | 4.862 | 1.798 | 6.0 |

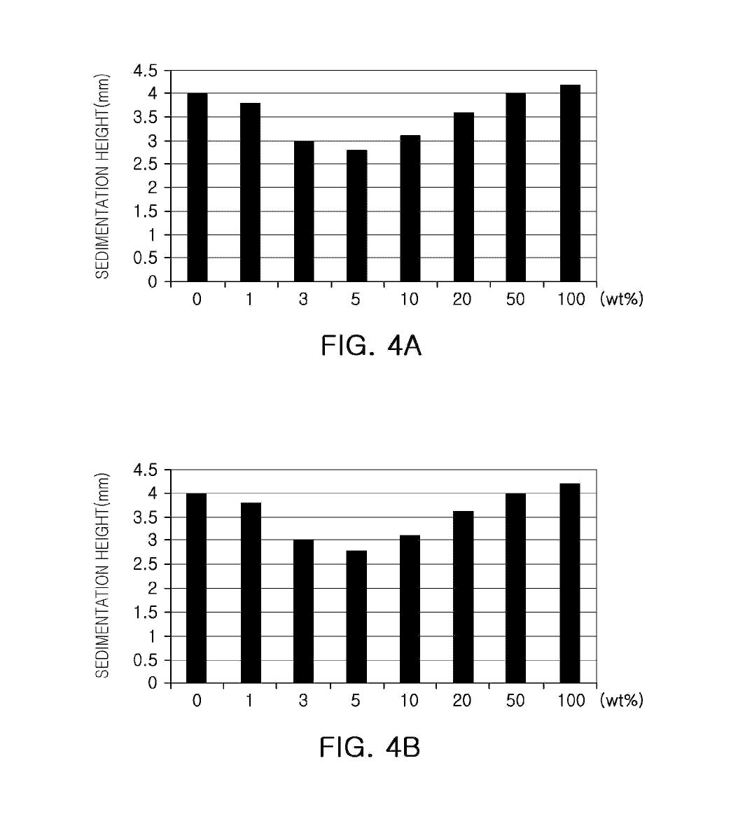

FIGS. 4A and 4B are graphs comparing degrees of sedimentation stability of a slurry depending on a content of an acryl-based resin and degrees of sedimentation stability of a slurry depending on a content of a polyvinyl butyral (PVB)-based resin, respectively.

It may be appreciated from Tables 1 and 2 and FIGS. 4A and 4B that in a case in which contents of the acryl-based resin and the polyvinyl butyral (PVB)-based resin are increased up to 5 wt %, a sedimentation height of a separation layer of the slurry may be decreased.

However, it may be confirmed that in a case in which contents of the acryl-based resin and the polyvinyl butyral (PVB)-based resin exceed 5 wt %, the sedimentation height of the separation layer of the slurry is again increased.

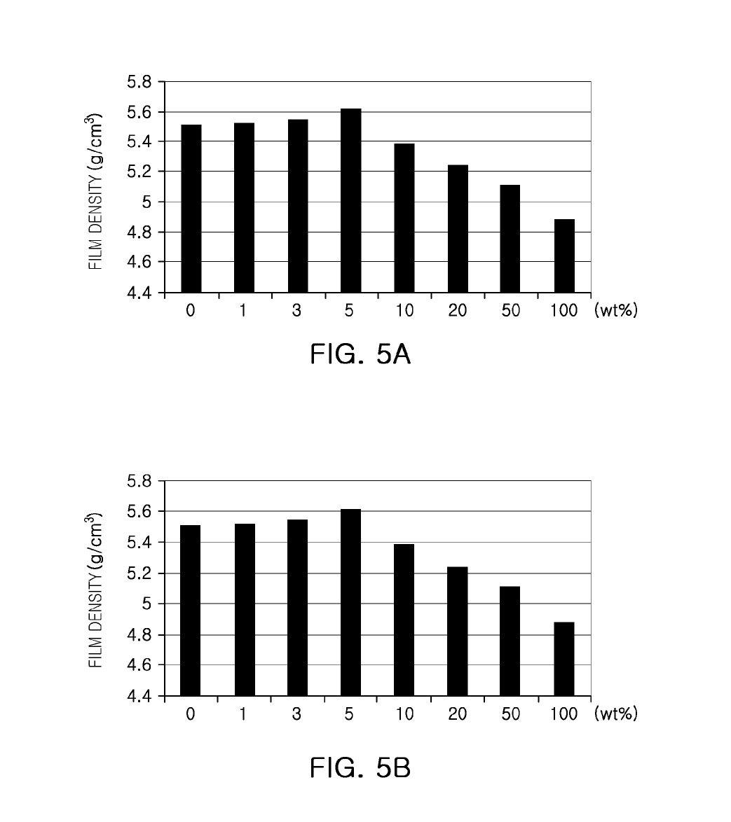

FIGS. 5A and 5B are graphs comparing degrees of film density of a magnetic sheet depending on a content of an acryl-based resin and degrees of film density of a magnetic sheet depending on a content of a polyvinyl butyral (PVB)-based resin, respectively.

It may be appreciated from Tables 1 and 2 and FIGS. 5A and 5B that when the contents of the acryl-based resin and the polyvinyl butyral (PVB)-based resin are increased up to 5 wt %, film density of the magnetic sheet is increased.

However, it may be confirmed that in the case in which the contents of the acryl-based resin and the polyvinyl butyral (PVB)-based resin exceed 5 wt %, the film density of the magnetic sheet is again decreased.

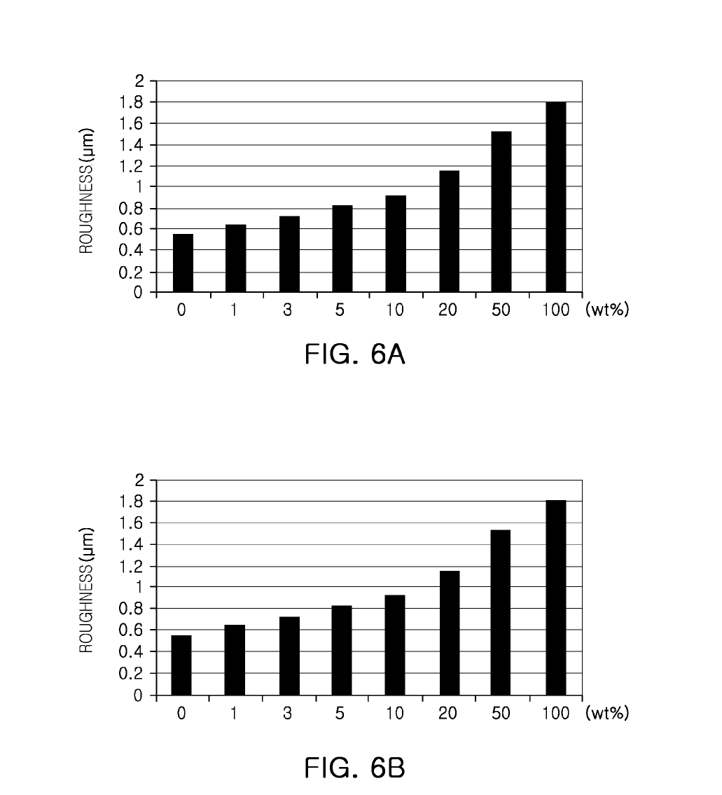

FIGS. 6A and 6B are graphs comparing degrees of surface roughness of a magnetic sheet depending on a content of an acryl-based resin and degrees of surface roughness of a magnetic sheet depending on a content of a polyvinyl butyral (PVB)-based resin, respectively.

It may be appreciated from Tables 1 and 2 and FIGS. 6A and 6B that in the case in which the contents of the acryl-based resin and the polyvinyl butyral (PVB)-based resin exceed 5 wt %, a surface roughness of the magnetic sheet is increased by exceeding 0.9 μm.

Next, the magnetic sheets may be stacked on both surfaces of the insulating substrate 20, respectively, and be compressed by a laminating method or an isostatic pressing method and be then hardened to form the magnetic body 50.

Here, in the case in which the content of the dispersing agent exceeds 5 wt %, the dispersing agent may be plasticized in a hardening process, such that a chip may be broken.

The following Table 3 shows strength of a chip before/after being hardened and a chip breakage frequency in high temperature, high humidity environments, depending on a content of the acryl-based resin, and the following Table 4 shows strength of a chip before/after being hardened and a chip breakage frequency in a high temperature, high humidity environment, depending on a content of the polyvinyl butyral (PVB)-based resin.

TABLE 3

| | | | | Strength of Chip | | | | | |
|---|---|---|---|---|---|---|---|---|---|
| | | | | Before/After Being | | | Chip Breakage | | |
| | Content (wt %) | | | Hardened (HV) | | | Frequency (%) | | |
| | Molecular | Molecular | Molecular | Molecular | Molecular | Molecular | Molecular | Molecular | Molecular |
| | Weight | Weight | Weight | Weight | Weight | Weight | Weight | Weight | Weight |
| | of | of | of | of | of | of | of | of | of |
| | 500,000 | 700,000 | 1,000,000 | 500,000 | 700,000 | 1,000,000 | 500,000 | 700,000 | 1,000,000 |
| 1 | 0 | 0 | 0 | 7.3/12.3 | 7.3/12.3 | 7.3/12.3 | 0 | 0 | 0 |
| 2 | 1 | 1 | 1 | 7.3/12.4 | 8.2/13.2 | 10.2/16.5 | 0 | 0 | 0 |
| 3 | 3 | 3 | 3 | 7.4/12.8 | 8.4/13.2 | 10.5/16.7 | 0 | 0 | 0 |
| 4 | 5 | 5 | 5 | 7.6/13.0 | 8.5/13.6 | 10.7/17.1 | 0 | 0 | 0 |
| 5 | 10 | 10 | 10 | 8.1/13.5 | 9.2/14.2 | 11.5/18.2 | 4 | 9 | 15 |
| 6 | 20 | 20 | 20 | 8.5/13.5 | 9.6/14.8 | 11.9/18.5 | 19 | 22 | 47 |
| 7 | 50 | 50 | 50 | 8.9/13.8 | 10.5/15.9 | 12.3/19.2 | 49 | 51 | 86 |
| 8 | 100 | 100 | 100 | 9.1/14.2 | 12.0/16.0 | 13.9/19.7 | 81 | 87 | 100 |

TABLE 4

| | | | | Strength of Chip | | | | | |
|---|---|---|---|---|---|---|---|---|---|
| | | | | Before/After Being | | | Chip Breakage | | |
| | Content (wt %) | | | Hardened (HV) | | | Frequency (%) | | |
| | Molecular | Molecular | Molecular | Molecular | Molecular | Molecular | Molecular | Molecular | Molecular |
| | Weight | Weight | Weight | Weight | Weight | Weight | Weight | Weight | Weight |
| | of | of | of | of | of | of | of | of | of |
| | 500,000 | 700,000 | 1,000,000 | 500,000 | 700,000 | 1,000,000 | 500,000 | 700,000 | 1,000,000 |
| 1 | 0 | 0 | 0 | 7.1/12.3 | 7.1/12.3 | 7.1/12.3 | 0 | 0 | 0 |
| 2 | 1 | 1 | 1 | 7.1/12.4 | 8.3/13.1 | 10.2/15.2 | 0 | 0 | 0 |
| 3 | 3 | 3 | 3 | 7.2/12.8 | 8.4/13.4 | 10.4/15.5 | 0 | 0 | 0 |
| 4 | 5 | 5 | 5 | 7.5/13.0 | 8.7/13.7 | 10.4/15.9 | 0 | 0 | 0 |
| 5 | 10 | 10 | 10 | 7.9/13.5 | 9.5/14.5 | 11.7/16.5 | 6 | 12 | 20 |
| 6 | 20 | 20 | 20 | 8.1/13.5 | 9.9/14.9 | 12.0/17.1 | 23 | 32 | 45 |
| 7 | 50 | 50 | 50 | 8.4/13.8 | 10.7/15.5 | 12.8/18.2 | 52 | 61 | 90 |
| 8 | 100 | 100 | 100 | 8.6/14.2 | 11.5/16.5 | 13.7/18.9 | 86 | 95 | 100 |

It may be appreciated from Tables 3 and 4 that as the contents of the acryl-based resin and the polyvinyl butyral (PVB)-based resin are increased, the strength of the chip is increased. However, in the case in which the contents of the acryl-based resin and the polyvinyl butyral (PVB)-based resin exceeded 5 wt %, chip breakage occurred, and a chip breakage rate was increased as a molecular weight was increased.

Next, the external electrodes 80 may be disposed on both end surfaces of the magnetic body 50 to be connected to the lead portions of the internal coil parts 42 and 44 respectively exposed to both end surfaces of the magnetic body 50.

The external electrode 80 may be formed using a paste containing a metal having excellent electrical conductivity, for example, a conductive paste containing nickel (Ni), copper (Cu), tin (Sn), or silver (Ag), or alloys thereof.

The external electrode 80 may be formed by a dipping method, or the like, as well as a printing method depending on a shape thereof.

As set forth above, according to the exemplary embodiment in the present disclosure, excellent dispersing properties and a sedimentation preventing effect may be obtained in the magnetic particles, and magnetic sheets having a high degree of uniformity may be manufactured.

In addition, the dispersibility of the magnetic particles may be improved, such that the packing factor may also be improved, and a high degree of inductance may be secured.

While exemplary embodiments have been shown and described above, it will be apparent to those skilled in the art that modifications and variations could be made without departing from the scope of the present invention as defined by the appended claims.

What is claimed is:

1. A chip electronic component comprising:
a magnetic body in which an internal coil part is embedded,
wherein the magnetic body comprises:
magnetic metal particles;
a thermosetting resin; and
a dispersing agent comprising one or more selected from the group consisting of an acryl-based resin and a polyvinyl butyral (PVB)-based resin.

2. The chip electronic component of claim 1, wherein a content of the dispersing agent is 1 wt % to 5 wt %, based on the thermosetting resin.

3. The chip electronic component of claim 1, wherein an average molecular weight of the acryl-based resin is 500,000 to 1,000,000.

4. The chip electronic component of claim 1, wherein an average molecular weight of the polyvinyl butyral (PVB)-based resin is 50,000 to 100,000.

5. The chip electronic component of claim 1, wherein the thermosetting resin is one or more selected from a group consisting of an epoxy resin and a polyimide resin.

6. The chip electronic component of claim 1, wherein the magnetic metal particles are an alloy comprising one or more selected from the group consisting of iron (Fe), silicon (Si), chromium (Cr), aluminum (Al), and nickel (Ni).

7. The chip electronic component of claim 1, wherein a particle diameter of the magnetic metal particle is 0.1 to 30 μm.

8. A method of manufacturing a chip electronic component, comprising:
forming an internal coil part on at least one surface of an insulating substrate; and
forming a magnetic body in which the internal coil part is embedded by stacking magnetic sheets on upper and lower portions of the insulating substrate which the internal coil part is formed,
wherein the magnetic sheet comprises magnetic metal particles, a thermosetting resin, and a dispersing agent comprising one or more selected from the group consisting of an acryl-based resin and a polyvinyl butyral (PVB)-based resin.

9. The method of manufacturing a chip electronic component of claim 8, wherein a content of the dispersing agent is 1 wt % to 5 wt %, based on the thermosetting resin.

10. The method of manufacturing a chip electronic component of claim 8, wherein a film density of the magnetic sheet is 5.4 g/cm³ or more.

11. The method of manufacturing a chip electronic component of claim 8, wherein a surface roughness of the magnetic sheet is 0.9 μm or less.

12. The method of manufacturing a chip electronic component of claim 8, wherein an average molecular weight of the acryl-based resin is 500,000 to 1,000,000.

13. The method of manufacturing a chip electronic component of claim 8, wherein an average molecular weight of the polyvinyl butyral (PVB)-based resin is 50,000 to 100,000.

14. The method of manufacturing a chip electronic component of claim 8, wherein the thermosetting resin is one or more selected from the group consisting of an epoxy resin and a polyimide resin.

15. The method of manufacturing a chip electronic component of claim 8, wherein the magnetic metal particles are an alloy comprising one or more selected from the group consisting of iron (Fe), silicon (Si), chromium (Cr), aluminum (Al), and nickel (Ni).

16. The method of manufacturing a chip electronic component of claim 8, wherein a particle diameter of the magnetic metal particles is 0.1 to 30 μm.
